(19) United States
(12) Patent Application Publication
(10) Pub. No.: US 2003/0040315 A1
(43) Pub. Date: Feb. 27, 2003

(54) Reduced state transition delay and signaling overhead for mobile station state transitions

(76) Inventors: Farideh Khaleghi, San Diego, CA (US); Anthony C.K. Soong, Superior, CO (US); Jonas Wiorek, San Diego, CA (US); Patrik Nils Lundgvist, Encinitas, CA (US); Shawn Shiau-He Tsai, San Diego, CA (US); Young C. Yoon, San Diego, CA (US)

Correspondence Address: COATS & BENNETT, PLLC, P O BOX 5, RALEIGH, NC, 27602, US

(21) Appl. No.: 10/210,634

(22) Filed: Jul. 31, 2002

Related U.S. Application Data
(60) Provisional application No. 60/313,451, filed on Aug. 20, 2001.
(60) Provisional application No. 60/330,403, filed on Oct. 18, 2001.
(60) Provisional application No. 60/337,030, filed on Nov. 7, 2001.
(60) Provisional application No. 60/360,373, filed on Feb. 28, 2002.

(51) Int. Cl. H04Q 7/20

(52) U.S. Cl. 455/435; 455/574

(57) ABSTRACT

A wireless communication network reduces its signaling overhead by recognizing when a mobile station transitions from an inactive state, such as Control Hold or quasi-active, back to an active state. Based on such recognition by the network, the mobile station begins sending desired traffic data without need for explicitly negotiating its return to active state, thereby reducing or eliminating higher-layer signaling, e.g., Layer 3 and above, that is otherwise required for return to active state operations. The network might further avoid explicit signaling by, for example, using transmitted reverse link Power Control Bits to indicate that an inactive mobile station should remain inactive. In this manner, inactive mobile stations may be allowed to return to active state without explicit signaling where appropriate, or held in the inactive state if needed, all without need for explicit network signaling.

### RELATED APPLICATIONS

This application claims priority under 35 U.S.C. §119(e) from the following U.S. provisional applications: Application Serial No. 60/313,451 filed on Aug. 20, 2001, Application Serial No. 60/330,403 filed on Oct. 18, 2001, Application Serial No. 60/337,030 filed on Nov. 17, 2001, and Application Serial No. 60/360,373 filed on Feb. 28, 2002. These applications are expressly incorporated in their entireties by reference herein.

### BACKGROUND OF THE INVENTION

The present invention generally relates to wireless communication network management, and particularly relates to reduced signaling for mobile station state transitions.

Increasing the number of users supported by a given network implementation represents an ongoing challenge in the design and operation of wireless communication networks. Operator revenue directly depends on efficient utilization of the various network resources, as inefficiencies within the network artificially limit the number of simultaneous users, thereby limiting the operator's ability to provide service to the greatest number of users at any given instant in time.

Developing wireless standards offer a range of services primarily built on an underlying packet data structure. Examples of such services include, but are not limited to, email, Web browsing, Instant Messaging (IM), multicasting, multimedia streaming, and various Short Messaging Services (SMS), including stock tickers and weather/travel updates. While the type of information provided by such packet data services varies significantly from the users' perspective, such traffic has, to at least some degree, one or more common characteristics from the network's perspective.

One relatively dramatic difference between packet data services and legacy voice services, e.g., circuit-switched voice/fax services, is that packet data connections carry “bursty” data. Simply put, packet data connections intermittently carry data, with the periods of non-activity depending upon the nature of the service or services being supported by a given data connection. For example, a user engaged in Web browsing typically clicks a link, receives a page download, and peruses the downloaded page for some time before clicking another link or otherwise causing another page to load.

With unlimited network resources, no compelling reason exists for recognizing such periods of intermittency and a network would simply leave the user's resources dedicated to that user regardless of the intermittency of the data flow associated with the user. However, practical networks comprise finite resources, which must be efficiently managed to support as many users as possible. Thus, resources dedicated to a data connection not actively carrying data to the associated user may unnecessarily reduce network capacity if not managed with an awareness of the state of that connection, i.e., active or inactive.

Various approaches to more efficiently utilizing such resources involve managing users' data connections based on the “states” of those connections. With the connection state approach, network resources are managed in a state-based approach. For example, resources may be incrementally allocated and deallocated in staged fashion based on the particular state of a given data connection. In cdma2000 networks for example, the Medium Access Control (MAC) Layer defines the following states: Active, Control Hold, Suspended, and Dormant.

In the Active state, the network maintains a full allocation of resources, including dedicated MAC and traffic channels, such that data may be actively received from or transmitted to a user's mobile station. If no data is transferred between the network and the user's mobile station within a defined time window, the user's data connection may transition to the Control Hold (CH) state. Some implementations of the Control Hold state release the user's dedicated traffic channels, while others retain such resources. Generally, however, mobile stations in the Control Hold state reduce their reverse link activity by, for example, transmitting a gated pilot signal. Gating the pilot signal effectively reduces the time-average transmit power of the pilot signals and thereby lowers reverse link interference in the network. Reduced reverse link interference increases system capacity, thus the network can gain a capacity advantage through state-based management of mobile stations.

While the above state-based approach may provide gains in network capacity, such gains can be largely undone if state management of the mobile stations requires long transition times to return mobile stations to active state and substantially increased signaling overhead. For example, maintaining mobile stations in different states, and particularly, handling the transition of mobile stations from one state to another requires an awareness of states within the network. One approach uses explicit network signaling to indicate the current state of a mobile station, or to control the transition of a mobile station from one state to another. However, increased control signaling between the various network entities reduces network capacity by consuming processing resources and inter-entity link bandwidth, and, therefore, anything that unduly increases the required signaling burden is undesirable.

### BRIEF SUMMARY OF THE INVENTION

The present invention provides a method and apparatus to reduce state transition delays and network signaling overhead in managing mobile station state transitions. More particularly, exemplary embodiments of the present invention comprise techniques for managing the transition of mobile stations from one or more inactive states, such as “Control Hold,” to the “Active” state. As used herein, the term “Control Hold state” refers to a mobile station state characterized by reduced reverse link activity, and encompasses the literal state definitions of Control Hold as defined in the cdma2000 network standards, as well as the broader and more generalized concepts of “quasi-active ” or “virtually active” states. More generally, the present invention applies to managing mobile-initiated transitions from a non-active state or condition to the active state, thus the references to exemplary states such as Control Hold should not be construed as limiting.

In an exemplary embodiment, mobile stations use implicit signaling recognized by network base stations to indicate mobile-initiated transitions back to the Active state. Recognition of such transitions at the base station avoids the need for higher-layer network signaling. Implicit signal detection includes, but is not limited to, detecting characteristic changes in one or more reverse link signals, detecting unscheduled data transmissions, and detecting implicit signaling in reverse link control and/or signaling channels. Thus, a base station can generally recognize a given mobile station's return to Active state operation by monitoring the activity on one or more reverse link channels associated with that mobile station. The base station may provide an indication, such as a transition acknowledgement to the mobile station, when transition to the active state by the MS is detected.

In an exemplary embodiment, base stations recognize when a given mobile station has transitioned back to the Active state by detecting changes in received energy in the pilot signal from that mobile station. Such changes arise because the mobile station changes from transmitting a gated pilot signal while in Control Hold, to transmitting a continuous pilot signal in the Active state. Thus, received pilot signal energy characteristically changes as the mobile station transitions to Active state operation.

The gating ratio used in Control Hold varies from, for example, a one-half to a one-quarter on/off ratio, but regardless of the specific ratio used, the average received energy for the pilot signal from a given mobile station changes perceptibly as that mobile station switches from gated to continuous pilot signal transmission. Such pilot signal detection may be based on non-coherent detection methods, and, under some circumstances, may be based on coherent pilot detection. Further, joint detection of the pilot and one or more other reverse link signals may be used. Coherent or non-coherent detection of other signals transmitted in association with the pilot may be used as appropriate or desired. In other embodiments, coherent or non-coherent detection of one or more reverse link channel signals other than the pilot signal may be used to detect the mobile-initiated transition to active state.

While providing a basis for implicit Control Hold-to-Active state signaling, the use of gated pilot signals may complicate the network's reverse link power control operations. Ordinarily, the network uses the pilot signal received from a given mobile station to generate Power Control Bits (PCBs), which are used to control that mobile station reverse link transmit power. Gated portions of the mobile station pilot signal provide no basis for the network's generation of the PCBs. Thus, the network might adopt a reduced rate power control approach wherein it generates PCBs only when the mobile station actively transmits its pilot signal, and otherwise suspends PCB generation during the gated portions.

In another exemplary embodiment of the present invention, such complications surrounding the selective generation of PCBs at the network are eliminated by programming the mobile stations to distinguish between valid PCBs that were generated responsive to active portions of their R-PICH signals versus invalid PCBs that were generated during gated (non-active) portions of the R-PICH signals. In other words, the mobile stations perform reverse link power control based on the valid PCBs while ignoring the invalid PCBs. In this manner, the network logic is simplified in that PCBs are generated at the nominal Active state rate regardless of whether a mobile station is in the Active or Control Hold state.

In still another exemplary embodiment, the network takes advantage of full rate power control during Control Hold states by using invalid PCBs as signaling bits. With this approach, the network uses PCBs that correspond to gated portions of a given mobile station's R-PICH signal to send signaling or other information to that mobile station. Thus, rather than simply ignoring the invalid PCBs, the mobile station can inspect or otherwise decode them to recover the transmitted information. In this manner, the network gains an additional signaling channel for the transfer of desired data to the mobile station during the mobile station Control Hold state without need for assigning or using an additional channel to the mobile station. In an exemplary embodiment, the network uses implicit signaling via the invalid PCBs to indicate that a given mobile station should remain in Control Hold, or otherwise delay its transition back to the Active state.

In general, then, the present invention may be used at a base station to implicitly recognize a mobile station's transition (or attempted return) from a non-active state to the Active operations based on detecting one or more characteristic changes in one or more reverse link signals associated with that mobile station. Such changes include, but are not limited to, characteristic changes in signal energy signifying a return to active state, the receipt of valid data, etc. Configuring the base stations to detect mobile-initiated Active state transitions eliminates the need for higher-level network signaling otherwise required between the mobile stations and supporting base station controllers.

By eliminating the requirement for such signaling to effect the state transition, the network gains efficiency through reduced signaling overhead. Moreover, transition performance improves by eliminating the signaling delays associated with higher-layer messaging between the base stations and base station controllers, which may then allow the overall network to gain efficiency by making it more efficient and practicable to transition mobile stations into the Control Hold state more frequently.

### BRIEF DESCRIPTION OF THE DRAWINGS

FIG. 1 is a diagram of an exemplary wireless communication network for practicing the present invention.

FIG. 2 is a diagram of exemplary activity states for mobile stations operating in the network of FIG. 1.

FIG. 3 is a diagram of an exemplary network signaling layer hierarchy.

FIG. 4 is a diagram of exemplary reverse link channels on which signals might be transmitted from a mobile station to a network.

FIG. 5 is a diagram of exemplary reverse channel activity monitoring for mobile-initiated Active state transitions.

FIG. 6 is a diagram of exemplary network signaling to coordinate a return to full-rate power control by base stations supporting a mobile station that has undergone a mobile-initiated transition to Active state operations.

FIG. 7 is a diagram of valid and invalid Power Control Bit generation by the network in relation to receiving a gated pilot signal from a mobile station in a Control Hold state.

FIG. 8 is a diagram of exemplary signaling to prevent or defer a mobile-initiated return to Active state.

### DETAILED DESCRIPTION OF THE INVENTION

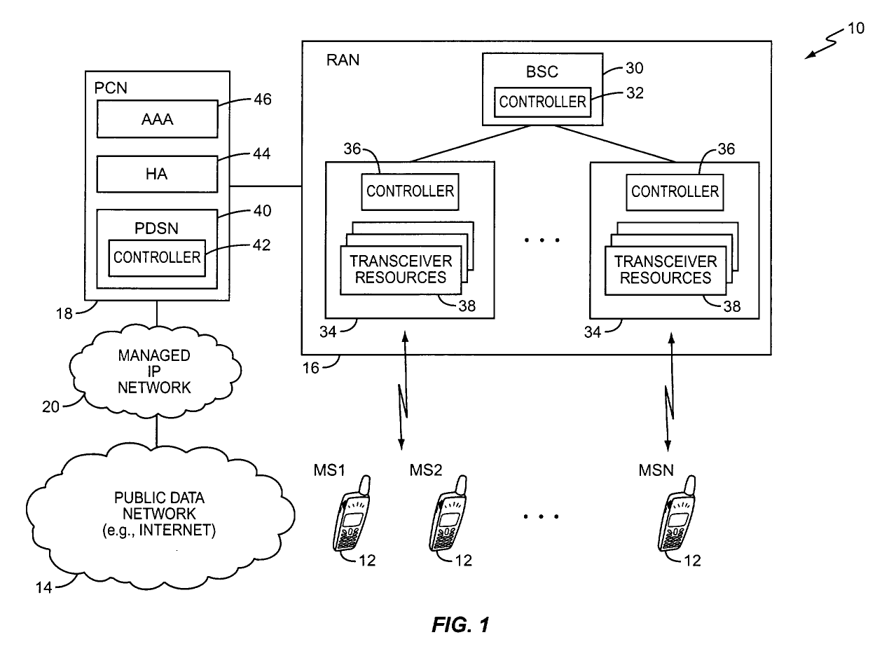

FIG. 1 illustrates an exemplary wireless communication network generally referred to by the numeral 10. In an exemplary embodiment, network 10 is based on 1xEV-DO/DV standards as promulgated by the Telecommunications Industry Association (TIA), although the present invention is not limited to such implementations. Here, network 10 communicatively couples one or more mobile stations (MSs) 12 to a Public Data Network (PDN) 14, such as the Internet. In support of this functionality, network 10 comprises a Radio Access Network (RAN) 16 and a Packet Core Network (PCN) 18. Typically, the PCN 18 couples to PDN 14 through a managed IP network 20, which operates under the control of network 10.

RAN 16 typically comprises one or more Base Station Controllers (BSCs) 30, each including one or more controllers 32 or other processing systems. Generally, each BSC 30 is associated with one or more Base Stations (BSs) 34. Each BS 34 comprises one or more controllers 36, or other processing systems, and assorted transceiver resources 38 supporting radio communication with MSs 12, such as modulators/demodulators, baseband processors, radio frequency (RF) power amplifiers, antennas, etc.

BSs 34 may be referred to as Base Transceiver Systems (BTSs) or Radio Base Stations (RBSs). In operation, BSs 34 transmit control and traffic data to MSs 12, and receive control and traffic data from them. BSC 30 provides coordinated control of the various BSs 34, and communicatively couples the RAN 16 to PCN 18 through, for example, a Packet Control Function (PCF) that interfaces to PCN 18 via a Radio Packet Network (RPN) link.

PCN 18 comprises a Packet Data Serving Node (PDSN) 40 that includes one or more controllers 42, or other processing systems, a Home Agent (HA) 44, and an Authentication, Authorization, and Accounting (AAA) server 46. The PDSN 40 operates as a connection point between the RAN 16 and the PDN 14 by establishing, maintaining and terminating Point-to-Point Protocol (PPP) links, and further provides Foreign Agent (FA) functionality for registration and service of network visitors. HA 44 operates in conjunction with PDSN 40 to authenticate Mobile IP registrations and to maintain current location information in support of packet tunneling and other traffic redirection activities. Finally, AAA server 46 provides support for user authentication and authorization, as well as accounting services.

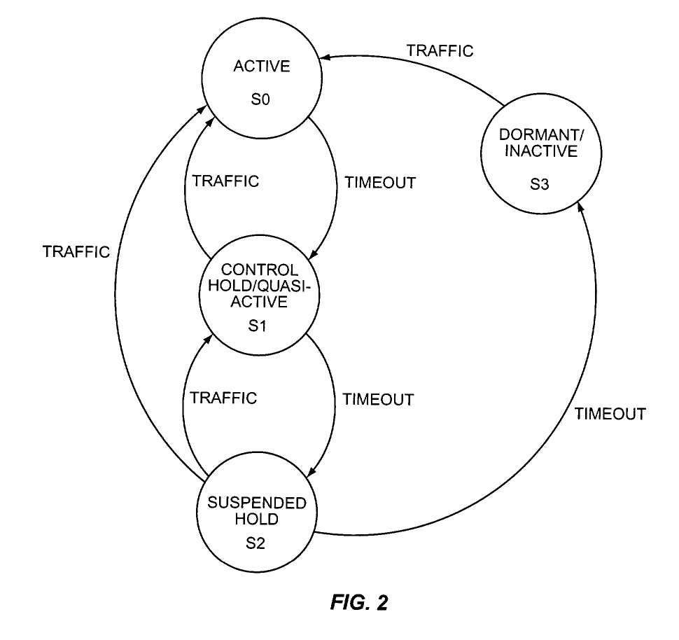

Network 10 provides wireless communication services to a plurality of users associated with MSs 12. To increase the number of users that it can simultaneously support and the system throughput, network 10 permits various MSs 12 to operate in one or more states of reduced activity at selected times. FIG. 2 illustrates exemplary state definitions in accordance with the state terminology adopted by the 1xEV-DV standards, but it should be understood that the invention is not limited to those standards, nor are the illustrated states limited to the particular state definitions in those standards. In this discussion, the Active state is characterized by active forward and/or reverse link traffic channel activity, and the Control Hold state is characterized by the cessation of forward link traffic channel activity and reduced reverse link activity.

Thus, MSs 12 that actively engage in receiving and/or transmitting traffic data operate in the Active state (S0). In at least some exemplary embodiments, traffic data inactivity is timed by the network 10 for each MS 12 and MSs 12 that remain inactive for longer than a specified timeout are transitioned to the Control Hold state (S1). With continued inactivity as measured by associated inactivity timers, those MSs 12 transition to Suspended Hold state (S2), and then into Dormant state (S3). Other embodiments may use other information for determining and/or controlling state transitions, such as mobile station distance from the base station or channel conditions. Further, such techniques may, if desired, be combined with timing-based techniques.

States S1-S3 may be viewed as measured degrees of inactivity. That is, they are all “inactive states,” but Control Hold state generally differs from the Suspended Hold and Dormant states in that the network 10 and the affected MS 12 remain essentially ready to resume active communication. For example, network 10 might physically release dedicated traffic and/or control channels allocated to a given MS 12 upon that mobile transitioning into Suspended Hold or Dormant states. In contrast, such channels may be retained, at least in terms of their logical assignment to a given MS 12 when the MS 12 transitions from the Active state to the Control Hold state. In this sense, the Control Hold state may not free as many communication resources, e.g., radio channels, Walsh code assignments, as the other, increasingly dormant states. Nonetheless, the Control Hold state still offers advantages over the Active state through its adoption of reduced reverse link activity.

Reducing the reverse link activity of a MS 12 in Control Hold increases the network's reverse link capacity and improves mobile station battery life. CDMA networks are, in general, “interference limited” systems, meaning that network capacity is influenced by the level of interference. While MSs 12 do not transmit Reverse Link Traffic Channel (R-TCH) signals in Control Hold state, they do still transmit Reverse Link Pilot Channel (R-PICH) signals. Each of these transmitted pilot signals contributes to the overall level of interference experienced by network 10 on the reverse link. Thus, by configuring MSs 12 to transmit a discontinuous or reduced duty cycle R-PICH signal while in Control Hold state, the total pilot signal energy on the reverse link is reduced and the effective level of reverse link interference correspondingly decreases.

Further interference reduction may derive from suspending or gating the transmission of other reverse link control and/or signaling signals from MSs 12 that are in one of the inactive states, such as Control Hold. For example, some network configurations use channel quality information from MSs 12 to set forward link data rates for transmitting to the MSs 12. In a 1xEV-DO/DV system, each MS 12 transmits a Data Rate Control (DRC) channel signal or a Channel Quality Indicator (CQI) channel signal to network 10, which uses the information to set the data rate for serving that MS 12 on the Forward Link Common Shared Channel (F-CSCH). In some embodiments of the present invention, MSs 12 may suspend such data rate control transmissions, thereby further reducing reverse link interference.

Whether or not suspension of selected other reverse link control and/or signaling channels is used, gating of the R-PICH signal for MSs 12 in Control Hold state or another one of the inactive states improves mobile station battery life by reducing the time-average transmit power of the R-PICH signal. Thus, reverse pilot signal gating during Control Hold state offers at least the dual advantages of increased reverse link capacity and improved mobile station battery life. However, the use of Control Hold or other such inactive states can diminish the apparent responsiveness or perceived performance of network 10 from the perspective of users associated with MSs 12 that have been transitioned to Control Hold state.

Such perceptions may arise, for example, where the transition of a given MS 12 from Control Hold back to Active state is delayed because of required high-level network signaling. In conventional approaches to Control Hold management, network 10 requires higher-level signaling with MS 12 to “negotiate” or otherwise manage the mobile station's return to the Active state. Such signaling is typically required in conventional approaches even where network 10 has only logically released the mobile station's dedicated traffic channel(s) on the reverse link. Because such higher level network signaling involves entities such as the BSC 30, delays may arise in association with conveying signaling messages between the BSs 34 and the BSC 30 on the backhaul link(s) connecting them.

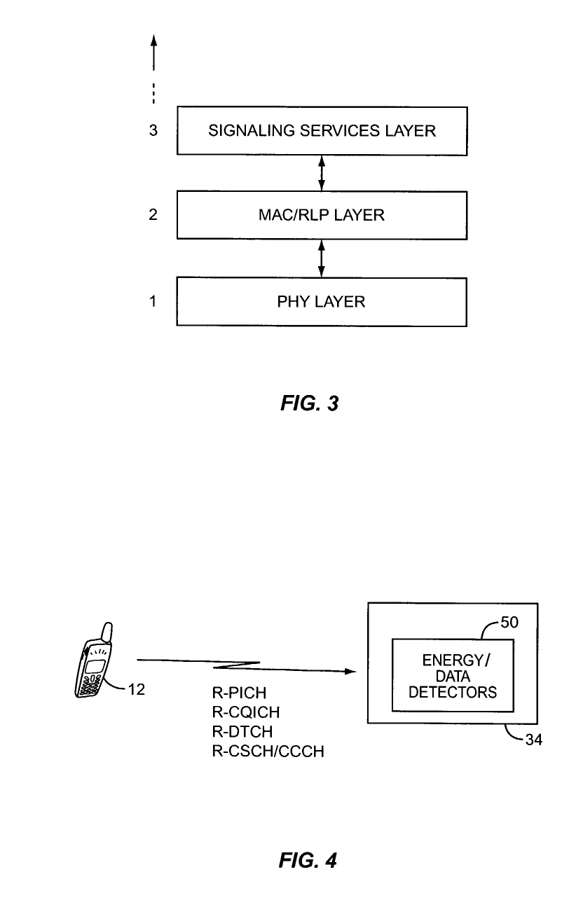

FIG. 3 illustrates a simplified network layer stack, which comprises Layer 1, Layer 2, and Layer 3 and so on. Layer 1 represents the Physical Layer and involves management of the radio resources that support the air interface between the network 10 and the MSs 12. Layer 2 represents the Medium Access Control Layer and Link Access Control (LAC), which provide relatively low-level support for the logical organization of the traffic and control data intended for the various MSs 12. Layer 2 further interfaces with Layer 3 via a Radio Link Protocol (RLP). Layer 3 and those above Layer 3 represent the higher-level signaling services, protocol stacks, and applications that together provide for high-level network control, management, and traffic conveyance.

Generally, Layer 3 signaling involves the BSC 30. Therefore, any Layer 3 or higher message that is generated in response to a certain mobile station's actions must be carried to the higher layer protocols over the backhaul link(s) that communicatively couple the BSC 30 with the various BSs 34. As such, there is potentially appreciable delay associated with transitioning a given MS 12 from Control Hold state back to Active state using Layer 3 signaling. In addition to such performance issues, management of the mobile's transition back to Active state via Layer 3 signaling imposes additional signaling overhead on the network 10. The present invention provides, in one or more exemplary embodiments, techniques for avoiding such signaling by allowing mobile-initiated return (or attempted return) to Active state without need for higher-level network signaling.

FIG. 4 illustrates an exemplary set of reverse link channels over which signals are transmitted from a MS 12 to the network 10 while the mobile station is in, for example, the Control Hold state. As illustrated, the MS 12 may transmit one or more of the following signals:

a Reverse Pilot Channel (R-PICH) signal;

a Reverse Channel Quality Indicator Channel (R-CQICH) signal;

a Reverse Dedicated Traffic Channel (R-DTCH) signal; and

a Reverse Common Signaling or Control Channel (R-CSCH/CCCH) signal.

The above listing is not comprehensive or limiting and it should be understood that other network standards might define differently named channels of like or similar functionality. Further, it should be understood that the R-CQICH channel signal encompasses the Data Rate Control (DRC) channel signal used in 1xEV-DO systems, and that the R-CSCH/CCCH signal may comprise a Reverse MAC Channel signal.

In an exemplary embodiment, each BS 34 comprises one or more energy and/or data detectors 50, which might be implemented using transceiver resources 38, controller 36, or some combination thereof. In any case, network 10 monitors one or more of the reverse link channel signals transmitted by MS 12 such that it recognizes a characteristic change in one or more of those signals indicative of the mobile station's transition from Control Hold state back to Active state. The ability to recognize such transitions at the base station level permits network 10 to avoid Layer 3 signaling to negotiate such a transition. Further, responsive to recognizing the MS's return to Active state operation, the network 10 can respond to the transition by allocating resources as needed, and begin actively receiving traffic from the MS 12.

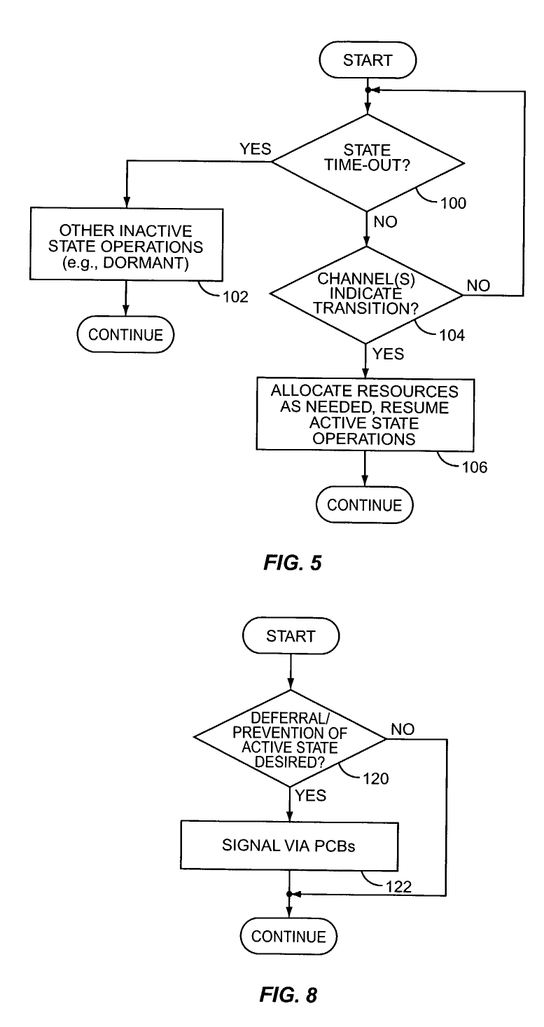

FIG. 5 illustrates exemplary network-based logic supporting mobile-initiated return to the Active state from Control Hold. In the scenario illustrated, a given MS 12 is in the Control Hold state, with network 10 timing its inactivity as part of the overall state control scheme. Thus, the network 10 might maintain a first inactivity timer for timing the MS's inactivity in the Control Hold state such that the MS 12 can be transitioned to the Suspended Hold or Dormant state after a defined period of time in the Control Hold state. Note that state inactivity timing may be based on variably defined timeouts or expiration periods that depend on, for example, the current number of users. Further, note that network 10 may generally control mobile station states based on other than timing information, as noted earlier herein.

In any case, network 10 determines whether a state timeout has occurred (Step 100) and, if so, transitions MS 12 to the next inactive state, or takes other appropriate action (Step 102) and processing continues accordingly. Absent such a timeout, network 10 begins (or continues) monitoring one or more reverse link channels associated with MS 12 for an indication of whether MS 12 has initiated a transition back to the Active state (Step 104). If such an indication is detected, network 10 allocates resources as needed, resumes Active state operations with respect to MS 12 (Step 106), and processing continues accordingly. Absent any such indication, network 10 continues with its monitoring subject to timeout constraints or other network control actions.

Reverse link monitoring for mobile-initiated return to Active state in the above logic is advantageously carried out by one or more of BSs 34, such that detection of the transition does not require higher level network signaling. For example, by configuring BSs 34 for such detection, MS 12 may implicitly signal its transition back to the Active state through Layer 1 (physical layer) and/or Layer 2 signaling, thereby avoiding Layer 3 signaling messages involving backhaul signaling to BSC 30. The energy/data detectors 50 introduced earlier may be used by BSs 34 to recognize such implicit signaling by MSs 12.

In an exemplary embodiment based on energy detection, a given BS 34 monitors, for a given MS 12 in Control Hold, one or both the reverse pilot (R-PICH) and reverse traffic (R-TCH) signals from the MS 12. In a typical implementation, MS 12 retains a dedicated reverse link traffic channels in Control Hold, although BS 34 might “logically” release the channel or otherwise assume that it is unused during Control Hold.

In any case, the reverse pilot and traffic channel signals generally exhibit a characteristic change in energy and/or activity responsive to MS 12 transitioning from Control Hold to Active state, and detection of such a change implicitly signals BS 34 that the MS 12 has made such a transition. For example, as MS 12 transitions from Control Hold to Active state, it changes its pilot signal from gated mode to continuous mode, thereby increasing the signal energy of its pilot signal as received by BS 34. Similarly, resuming active data transmissions on the reverse traffic channel increases the received signal energy for that channel at BS 34.

In an exemplary embodiment, BS 34 compares the received pilot signal energy for the MS 12 to a defined threshold. If the received energy exceeds that threshold, the BS 34 assumes that MS 12 has transitioned back to Active state. Rather than monitor the received pilot energy, the BS 34 might monitor the received signal energy for the reverse traffic channel, or one or more other reverse link channel signals associated with MS 12.

As the reverse link data channel normally does not carry traffic from the MS 12 while the mobile station is inactive, a detected increase in energy on the reverse traffic channel may be taken as an indication of resumed mobile station activity. Alternatively, the BS 34 may monitor the received energies for both the reverse pilot and traffic channels as the basis for detecting the mobile station's transition back to the Active state. If both channels are monitored, the BS 34 may employ a different energy threshold to qualify or otherwise evaluate the energy received on each monitored reverse link channel.

In an exemplary embodiment of mobile-initiated transition back to the Active state, the MS 12 implicitly signals such transitions by sending unscheduled packet data on its reverse dedicated traffic channel (R-DTCH) signal. Based on its monitoring of this signal, BS 34 detects the MS's transition and sends, for example, a Transition-Acknowledgement (T-ACK) to MS 12 indicating the network 10 has recognized its transition back to the active state.

In an exemplary embodiment of reverse traffic channel monitoring by BSs 34, a given one of the MSs 12 has generated a new packet for unscheduled transmission and initiates a Control-Hold-to-Active state transition, and sends the packet or a preamble directly on its reverse link traffic channel, e.g., the R-DTCH, to signal the transition. Each receiving BS 34 despreads the received reverse channel signal at a default symbol rate and detects if there is a new packet or preamble in the signal received on that reverse link channel during the ON-period of the mobile's gated pilot. A quantitative description of such traffic/preamble detection begins with expressing the discrete-time received symbol on the reverse link traffic channel as,

r_{m,I}=N\sqrt{E_{i,m}}(d_{m,I} cos φ+d_{m,Q} sin φ)+n_{I,m} and

r_{m,Q}=N\sqrt{E_{i,m}}(d_{m,I} sin φ+d_{m,Q} cos φ)+n_{Q,m},

where E_{c,m} is the received energy per chip during the mth symbol duration. d_{m,I} and d_{m,Q} are the in-phase (I) and quadrature (Q) data symbols, respectively. φ is the carrier phase. n_{I,m} and n_{Q,m} are the I- and Q-channel interference samples which are modeled as independent Gaussian random variables each with zero-mean and a variance of NI₀/2, where N is the spreading factor (number of chips per symbol) and I₀/2 is the two-sided power spectral density of the interference.

A noncoherent detector formulation for implementation by, for example, energy/data detectors 50, is obtained where the noncoherent decision is based on the sum of r_{m,I}² and r_{m,Q}², which results in chi-square (X²) distributed random variables. Usually, the X² distribution is defined as a function of unit-variance Gaussian random variables and denoted as,

X²(2M,θ₁)

where 2M is the degree of freedom (M is the number of symbols in the observation period) and θ is the non-centrality parameter. The statistic used for detecting the existence of the traffic signal is given as,

$$R = \frac{2}{{NI}_{0}} {\sum }_{m = 1}^{M} ( {r}_{m , 1}^{2} + {r}_{m , Q}^{2} )$$

where 2/NI₀ is the normalization constant. If there are signals being transmitted on the reverse traffic channel from MS 12, then the random variable R is a non-central X² random variable with 2M degrees of freedom and the non-centrality parameter

$${θ}_{1} = \frac{2 {\sum }_{m = 1}^{M} {N}^{2} {E}_{c , m}}{{NI}_{0}} = 2 MN Traffic {E}_{c} / {I}_{o} .$$

Since θ₁ only depends on the average E_{c}/Iₒ (energy over interference) over the observation period, different Eᵢ values due to the channel fading become nuisance parameters. Therefore, conditioned on the average E_{c}/Iₒ, the results can be applied to arbitrary fading channels. The average performance for different channels can be evaluated by averaging over their E_{c}/Iₒ distribution, however, the treatment herein focuses on the conditional scenario where a BS 34 has performed the measurement and detection. Usually, R is denoted as

R˜X²(2M,θ₁).

If there is no signal on the reverse traffic channel, then R is denoted as R˜X²(2M,0). The problem of non-coherent energy detection then becomes the hypothesis test of some non-zero θ₁ and 0. From detection, the uniformly powerful test (UMP) for such a detection problem is a threshold test, which is

R≧γz,900 signals transmitted on R-TCH, or

R<γz,900 no signals on R-TCH.

The threshold is represented by γ. The selection of γ should satisfy requirements on probability of false alarm P_{FA}, i.e., the probability of falsely detecting reverse link traffic channel signals. Given a required P_{FA}, receiver performance at the BS 34 is measured by the detection probability P_{D}. The threshold is uniquely determined by

γ=F₀⁻¹(1−P_{FA})

where F₀⁻¹ is the inverse cdf with the non-centrality parameter 0.

With the above analytical basis for non-coherent detection, one sees that monitoring the reverse link traffic channel (R-TCH) for signal activity, i.e., traffic or preamble data, preferably involves detecting signal energy for the channel, and comparing that energy to a defined threshold. The threshold may be set high enough to avoid problematic false detection, but be set low enough to ensure reliable detection of mobile-initiated return to Active state operations.

As an alternative to non-coherent detection, BSs 34 may employ coherent detection, which may be based on the Neyman-Pearson criterion, which criterion is known to those skilled in the art. Assuming known received bits and ideal symbol phase estimates, the BS receiver statistic can be expressed as in terms of hypotheses H₀ and H₁ as,

$${H}_{0} : R = {\sum }_{m = 1}^{M} {n}_{m} , and$$

$${H}_{1} : R = {\sum }_{m = 1}^{M} N \sqrt{{E}_{c , m}} + {n}_{m} .$$

Where the sequence of nₘ is zero-mean, i.i.d. Gaussian-distributed with a variance of NI₀/2. The probability of false alarm and that of detection for the R-TCH can be expressed, respectively, as,

P_{FA}=∫_{λ}^{∞}f_{R|H}_{₀}(r|H₀)dr=Q(λ), and

P_{D}=∫_{λ}^{∞}f_{R|H}_{₁}(r|H₁)dr=Q(\sqrt{β}−λ),

where Q(x)=1/(\sqrt{2π}∫ₓ^{∞} exp(−z²/2)dz, λ is the decision threshold value set to satisfy λ=Q⁻¹(P_{FA}) and β=2MNE_{c}/I₀ is the SNR of the statistic R. For R<λ, choose H₀, otherwise choose H₁.

In another exemplary embodiment, the reverse link traffic signal from an MS 12 can be monitored for the receipt of valid data as an indication that the MS 12 has transitioned from Control Hold back to the Active state. Thus, BS 34 may decode the traffic channel signal to determine whether valid data was received, such as by performing Cyclic Redundancy Check (CRC) verification or other error coding check on the received data. In this manner, the receipt of valid data from MS 12 serves as the implicit signal that MS 12 has transitioned back to Active state.

In still other exemplary embodiments, MSs 12 might implicitly signal their return to Active state using one or more reverse link control and/or signaling channels. For example, in 1xEV-DV networks, MSs 12 may use their reverse link Channel Quality Indicator (CQI) signals to indicate Active state transitions. In such embodiments, BSs 34 are configured to recognize CQI-based signaling, which might involve detecting a characteristic pattern or value applied to the CQI signal, or might simply involve recognizing a resumption of CQI transmissions by a given MS 12 as an indication that that mobile station has transitioned to the Active state.

Other exemplary control channel signaling might involve implicit signaling on a reverse link MAC channel or other Reverse Link Dedicated Control Channel (R-DCCH). With this approach, a given MS 12 might send a traffic data packet on the control channel rather than the expected control signaling. Receipt of traffic on the control channel would be recognized by the BSs 34 as implicitly indicating that the MS 12 was transitioning back to the Active state. As an alternative to sending traffic on the control channel, MSs 12 may be configured to change symbol patterns, encoding, modulation, or some combination thereof, on a designated reverse link control channel, such that recognizing such a characteristic change at the BSs 34 serves as the implicit signaling.

Where MSs 12 transmit gated pilot signals while in Control Hold, the network 10 might, as noted, reduce its power control rate based on sending PCB's to the various mobiles only for the non-gated portions of the MSs' pilot signals. Thus, where a given MS 12 uses a duty cycle of 50% to gate its pilot signal, the network's power control rate for that mobile's reverse link would drop to one-half the nominal Active state rate. In other words, if the network 10 nominally transmits PCBs to the MS 12 at, for example, a rate of 800 Hz while the MS 12 is in the Active state, that rate would drop to 400 Hz when the MS 12 is in the Control Hold state.

Where BSs 34 reduce the rate of their transmitted PCBs to accommodate the reduced duty cycle of a mobile station's gated pilot signal, certain complications may arise when the MS 12 performs a mobile-initiated return to the Active state. Such complications particularly arise where one or more of BSs 34 are sending PCBs to the MS 12. If one of the BSs 34 fails to detect the implicitly signaled return to Active state, it continues sending reduced-rate PCBs although the BSs 34 that successfully detect the mobile station's implicitly signaled return to Active state transition from reduced rate to full-rate power control. Under such conditions, at least one BS 34 sends less than full rate PCBs to the MS 12, meaning that at given time instants the MS 12 receives valid PCBs from less than all BSs 34 supporting it on the reverse link.

As an example, assume that when inactive, the mobile station's reverse pilot signal was gated at a 50% duty cycle and its supporting BSs 34 had reduced the transmission rate of PCBs from the normal 800 Hz to 400 Hz. Upon transition of the MS 12 to Active state, all BSs 34 supporting the MS 12 on the reverse link should resume 800 Hz PCB transmissions. If one or more of those BSs 34 do not recognize the transition, they will continue sending PCBs at 400 Hz. Thus, with implicit signaling of the Active state, one BS 34 might resume full-rate power control while another BS 34 might continue reduced rate power control for the MS 12.

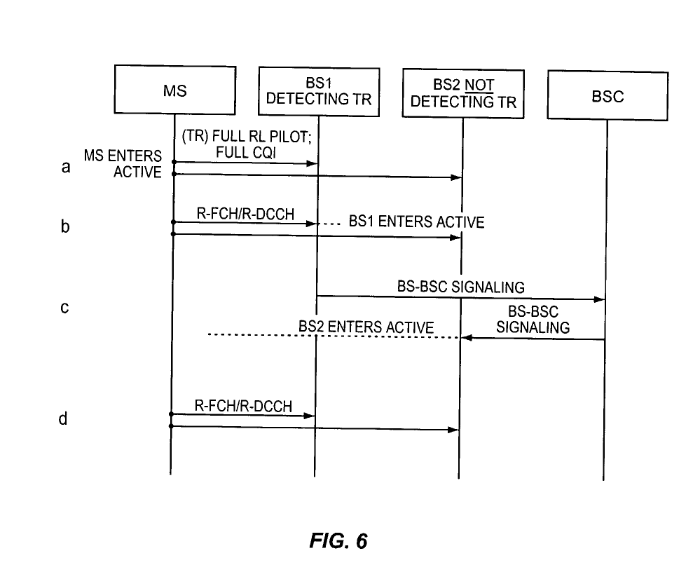

FIG. 6 illustrates an exemplary method for addressing the above scenario. The MS 12 resumes Active state operations, thereby resuming full reverse link pilot signal transmission. A first BS 34 (BS1) detects the change in the pilot signal and resumes Active state operations for MS 12, such as receiving data on the mobile's Reverse Link Fundamental Channel (R-FCH) and/or Dedicated Control Channel (R-DCCH) signals and resuming full-rate power control (Steps a and b). A second BS 34 (BS2) fails to detect the transition as implicitly signaled by the change in the MS's pilot signal, and thus does not resume full-rate power control. A defined time after recognizing the MS's transition, BS1 signals such transition to the BSC 30 (Step c), which then signals BS2 such that it begins active operations for MS 12 (Step d).

As an alternative to variable rate power control, BSs 34 might simply continue with full-rate power control, even for MSs 12 that are in Control Hold. That is, BSs 34 transmit PCBs at the same rate regardless of whether a given MS 12 is in the Active state or the Control Hold state. Consequently, some of the PCBs generated by a BS 34 for an MS 12 that is in Control Hold state will be invalid, while some of them will be valid. More particularly, PCBs corresponding to non-gated portions of the MS's pilot signal are valid, while PCBs corresponding to the gated portions of that signal are invalid.

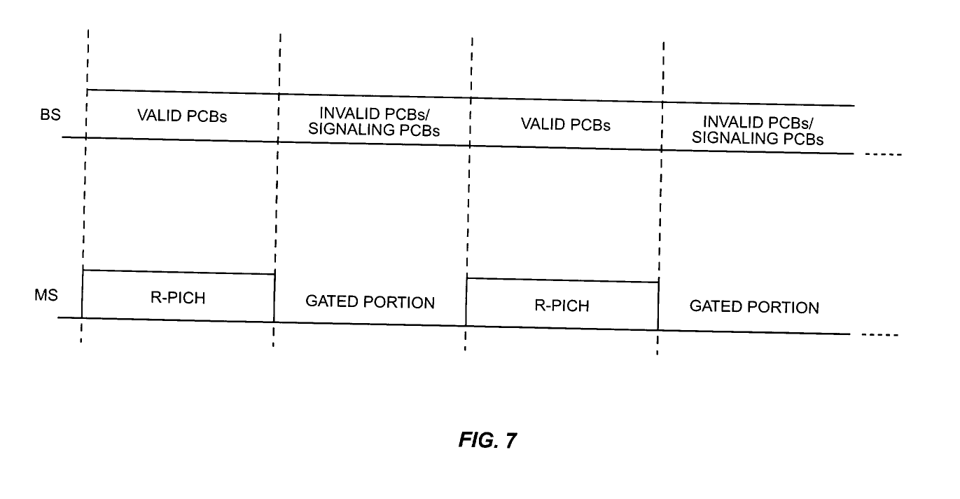

FIG. 7 illustrates the logical generation of PCBs according to this scheme, and illustrates the relationship between valid and invalid PCBs and the gated pilot signal from the MS 12.

Those skilled in the art will appreciate that, since there is some finite delay in the generation of PCBs, there may be valid PCBs being transmitted coincident with at least some part of the gated portions of the mobile station's pilot signal. Similarly, invalid PCBs may be transmitted coincident with at least some part of the non-gated portion of the mobile station's pilot signal. For example, an exemplary PCB generation delay is on the order of two Power Control Groups (PCGs), which equates to 2×1.25 ms in an exemplary embodiment. Regardless, timing synchronization between network 10 and MS 12 permits ready determination of which PCBs are valid versus invalid.

In exemplary embodiments of network 10 that adopt the above full-rate power control method, MSs 12 are configured to “ignore” the invalid PCBs. Such configuration is based on synchronizing reverse link power control at the MSs 12 such that valid PCBs are recognized and used for power control while invalid PCBs are ignored.

In an exemplary embodiment related to full-rate power control, the network 10 can be configured to use the invalid PCBs for implicit signaling to the MSs 12. Of course, this requires complementary configurations for the MSs 12 such that they recognize or otherwise decode such signaling from received invalid PCBs rather than simply ignoring them. One signaling use that may be applied to the invalid PCBs is an indication by network 10 of whether a given MS 12 should perform a mobile-initiated transition from Control Hold to Active.

FIG. 8 illustrates exemplary PCB-based signaling between one or more BSs 34 and a given MS 12. Processing begins with the MS 12 in Control Hold state. If network 10 desires MS 12 to remain in Control Hold (Step 120), one or more BSs 34 apply a defined signaling to one or more of the invalid PCBs transmitted from the BSs 34 to the MS 12 (Step 122) and processing continues. MS 12 recognizes the defined signaling as corresponding to a command to remain in the Control Hold state and therefore does not attempt to perform a mobile-initiated transition to the Active state.

Such PCB-based signaling might involve a simple polarity or binary pattern encoding, such that MS 12 processes the PCBs essentially as it would absent their use as implicit signaling bits. With such an approach, processing the received PCBs to determine implicitly signaled values or commands does not impose significant PCB processing overhead on the MSs 12. Of course, those skilled in the art should recognize that the idea of implicit signaling via PCBs is subject to differing implementations, and may be used to transfer other types of data and control a variety of operations at the MSs 12.

In general, the present invention includes exemplary embodiments that eliminate higher-level network signaling, e.g., Layer 3 signaling, in support of mobile-initiated transitions from non-active to Active states by recognizing implicitly signaled transitions at supporting base stations, such as by physical layer or Layer 2 signaling. Such implicit signaling involves, in exemplary embodiments, the base stations 34 detect characteristic changes of one or more reverse link signals from the mobile stations that implicitly signal a return to Active state operation by the MSs 12.

While certain exemplary details herein discuss detecting mobile-initiated Control-Hold to Active state transitions, the present invention is not limited to that exemplary operation. Indeed, those skilled in the art should understand that the present invention generally applies to implicitly recognizing inactive to active state transitions, wherein the term “inactive” broadly defines a range of non-active states. As such, the present invention is not limited by the exemplary embodiments discussed above rather it is limited only by the scope of the following claims and the reasonable equivalents thereof.

What is claimed is:

1. A method of recognizing mobile-initiated state transitions in a wireless communication network comprising:
monitoring at least one reverse link channel associated with a mobile station at a base station while the mobile station operates in an inactive state; and
recognizing a mobile-initiated transition from the inactive state to an active state at the base station by detecting a characteristic change in the at least one reverse link channel associated with the mobile station.

2. The method of claim 1, further comprising allocating selected resources for communication with the mobile station responsive to recognizing the mobile-initiated transition to the active state.

3. The method of claim 2, wherein allocating selected communication resources comprises allocating a reverse-link traffic channel to the mobile station.

4. The method of claim 1, wherein the inactive state comprises a Control Hold state.

5. The method of claim 1, wherein the inactive state comprises a quasi-active state.

6. The method of claim 1, wherein monitoring one or more of the reverse link channels comprises:
receiving at least one of a Reverse Pilot Channel (R-PICH) signal and a Reverse Traffic Channel (R-TCH) signal from the mobile station; and
detecting a received energy of at least one of the R-PICH and R-TCH signals.

7. The method of claim 6, wherein detecting a received energy of at least one of the R-PICH and R-TCH signals comprises coherently detecting the received energy of the R-PICH signal.

8. The method of claim 6, wherein detecting a received energy of at least one of the R-PICH and R-TCH signals comprises non-coherently detecting the received energy of the R-PICH signal.

9. The method of claim 6, wherein detecting a characteristic change of the at least one reverse link channel comprises detecting when a received signal energy for the at least one reverse link channel increases beyond an energy threshold.

10. The method of claim 6, wherein detecting a characteristic change of the at least one reverse link channel comprises detecting when the received energy of the R-TCH signal is above an energy threshold.

11. The method of claim 6, wherein detecting a characteristic change of the at least one reverse link channel comprises detecting when the received energies of the R-PICH and the R-TCH signals are above one or more energy thresholds.

12. The method of claim 1, wherein monitoring one or more of the reverse link channels comprises monitoring a Reverse Traffic Channel (R-TCH) associated with the mobile station for receipt of a valid data frame on a R-TCH signal.

13. The method of claim 12, wherein recognizing a mobile-initiated transition from the inactive state to the active state comprises recognizing the receipt of valid data in the R-TCH signal.

14. The method of claim 1, wherein monitoring the at least one reverse link channel comprises monitoring a Reverse Common Channel (R-CCH) signal to detect a data burst transmitted by the mobile station, wherein the detection of the data burst on the R-CCH signal is recognized as indicating the mobile station has transitioned to the active state.

15. The method of claim 1, wherein monitoring the at least one reverse link channel comprises monitoring a Reverse MAC Channel (R-MCH) signal for information transmitted by the mobile station.

16. The method of claim 15, wherein recognizing a mobile-initiated transition from the inactive state to the active state comprises recognizing a change in symbol modulation associated with the information transmitted by the mobile station on the R-MCH signal.

17. The method of claim 1, further comprising implicitly signaling to the mobile station that it should not begin active state operation.

18. The method of claim 17, wherein implicitly signaling to the mobile station that it should not begin active state operation comprises signaling via one or more reverse link Power Control Bits (PCBs) transmitted from the network to the mobile station.

19. The method of claim 19, wherein signaling via one or more reverse link PCBs comprises transmitting a polarity pattern of reverse link PCBs to the mobile station.

20. The method of claim 19, further comprising transmitting the polarity pattern of reverse link PCBs to correspond to a gated portion of a Reverse Pilot Channel (R-PICH) signal received as one of the one or more reverse link channels from the mobile station.

21. A base station for use in a wireless communication network to support mobile stations operating in active and inactive states, said base station operative to:
monitor at least one reverse link channel associated with a mobile station that is in an inactive state; and
recognize a mobile-initiated transition by the mobile station from the inactive state to an active state by detecting a characteristic change in the at least one reverse link channel.

22. The base station of claim 21, wherein the base station comprises one or more energy detectors, and wherein detecting a characteristic change in the at least one reverse link channel comprises detecting a characteristic change in received energy of one or more signals received on the at least one reverse link channel.

23. The base station of claim 22, wherein the one or more energy detectors comprise a non-coherent energy detector used by the base station to monitor a received signal energy of a pilot signal received from the mobile station on a reverse link pilot channel.

24. The base station of claim 22, wherein the base station uses the one or more energy detectors to detect energy changes in one or both a pilot signal and a data signal associated with the mobile station, such that the base station recognizes a characteristic increase in received energy as indicating a return by the mobile station to the active state.

25. The base station of claim 21, wherein the base station comprises a receiver operative to receive a data signal from the mobile station on the at least one reverse link channel, and wherein detecting a characteristic change in the at least one reverse link channel comprises detecting the receipt of valid data in the data signal.

26. The base station of claim 21, wherein the base station resumes active state communication with the mobile station based on recognizing the mobile-initiated transition to the active state at the base station.

27. The base station of claim 21, wherein the base station monitors a reverse pilot channel associated with the mobile station and recognizes the mobile-initiated transition to the active state by detecting a characteristic increase in received signal energy for the reverse pilot channel.

28. The base station of claim 21, wherein the base station monitors a reverse traffic channel associated with the mobile station and recognizes the mobile-initiated transition to the active state by detecting a characteristic increase in received energy for the reverse traffic channel.

29. The base station of claim 21, wherein the base station monitors reverse traffic and pilot channels associated with the mobile station and recognizes the mobile-initiated transition to the active state by detecting characteristic increases in received energies for the reverse traffic and pilot channels.

30. The base station of claim 21, wherein the base station monitors a reverse traffic channel associated with the mobile station and recognizes the mobile-initiated transition to the active state by detecting the characteristic change as a change from invalid to valid data received on the reverse traffic channel.

31. The base station of claim 21, wherein the base station transmits a Transition Acknowledgement (T-ACK) to the mobile station after recognizing the mobile-initiated transition to the active state, such that the mobile station is provided with an indicator that the mobile-initiated transition to the active state has been recognized by the network.

32. The base station of claim 31, wherein the base station does note transmit the T-ACK to the mobile station if active state operation by the mobile is undesirable.

33. The base station of claim 32, wherein if active state operation by the mobile station is undesirable, the base station transmits one or more reverse link power control bits (PCBs) to the mobile station that implicitly signal to the mobile station that the mobile station should return to the active state.

34. The base station of claim 21, wherein, if active state operation by the mobile station is not desired, the base station transmits one or more reverse link power control bits transmitted by the base station to the mobile station to implicitly signal to the mobile station that the mobile station should not return to the active state.

35. The network of claim 34, wherein the base station transmits valid and invalid power control bits to the mobile station, wherein one or more of the invalid power control bits carry implicit signaling information to the mobile station.

36. The network of claim 21, wherein the inactive state comprises a Control Hold state.

37. The network of claim 21, wherein the inactive state comprises a quasi-active state.

38. A mobile station for use in a wireless communication network, the mobile station operative to:
receive power control bits from a base station;
process the received power control bits as power control commands while the mobile station operates in a first state; and
process a first subset of the received power control bits as power control commands and a second subset of the received power control bits as implicit signaling bits while the mobile station operates in a second state.

39. A base station for use in a wireless communication network, said base station operative to:
transmit power control bits to a mobile station for controlling a reverse link transmit power of the mobile station; and
wherein the power control bits include one or more implicit signaling bits used for implicit signaling instead of reverse link power control.

40. The base station of claim 39, wherein the mobile station transmits a gated reverse link pilot signal to the base station during inactive state operation of the mobile station, and wherein the base station transmits the one or more implicit signaling bits at times corresponding to gated portions of the reverse link pilot signal.

41. The base station of claim 40, wherein the implicit signaling bits are used to indicate that the mobile station should not resume active state operations.
